(19) United States
(12) Patent Application Publication
(10) Pub. No.: US 2026/0286854 A1
(43) Pub. Date: Sep. 24, 2026

(54) STATOR BLADE AND GAS TURBINE COMPRISING SAME

(71) Applicant: MITSUBISHI HEAVY INDUSTRIES, LTD., Tokyo (JP)

(72) Inventors: Masahito KATAOKA, Tokyo (JP); Takeshi UMEHARA, Tokyo (JP); Keiya ISHIYAMA, Tokyo (JP)

(21) Appl. No.: 18/867,557

(22) PCT Filed: May 24, 2023
(86) PCT No.: PCT/JP2023/019272

§ 371 Date: Nov. 20, 2024

(30) Foreign Application Priority Data
May 31, 2022 (JP) 2022-089017

(51) Int. Cl. F01D 9/02; F01D 25/24

(52) U.S. Cl. CPC F01D 9/02; F01D 5/18; F01D 5/187; F05D 2240/126; F05D 2260/22141

(57) ABSTRACT

A stator blade includes a blade body including: a trailing end space and an adjacent space located between a leading edge and a trailing edge; and trailing end cooling passages penetrating from the trailing end space to the trailing edge. The adjacent space is located further on the leading edge side than the trailing end space. The edge of the trailing end space on the leading edge side is open and communicates with the trailing end space. Divider ribs are aligned in the blade height direction and divide the trailing end space in the blade height direction, and pins are arranged in the trailing end space. The pins are all joined to a positive pressure-side inner wall surface and a negative pressure-side inner wall surface defining the trailing end space. At least one divider rib forms an extending partition rib extending to the interior of the adjacent space.

This application claims the right of priority based on Japanese Patent Application No. 2022-089017 filed with the Japan Patent Office on May 31, 2022, the content of which is incorporated herein by reference.

### TECHNICAL FIELD

The present invention relates to a stator blade and a gas turbine including the same.

### BACKGROUND ART

A gas turbine includes a compressor that compresses air to generate compressed air, a combustor that combusts fuel in the compressed air to generate a combustion gas, and a turbine driven by the combustion gas. The turbine includes a turbine rotor that rotates around an axis, a turbine casing that covers the rotor, and a plurality of stator blade rows. The turbine rotor includes a rotor shaft around the axis, and a plurality of rotor blade rows attached to the rotor shaft. The plurality of rotor blade rows are aligned in an axial direction where the axis extends. Each of the rotor blade rows includes a plurality of rotor blades aligned in a circumferential direction with respect to the axis. The plurality of stator blade rows are aligned in the axial direction, and are attached to an inner peripheral side of the turbine casing. Each of the plurality of stator blade rows is disposed on an axial upstream side of one rotor blade row of the plurality of rotor blade rows. Each of the stator blade rows includes a plurality of stator blades aligned in the circumferential direction with respect to the axis.

The stator blade includes a blade body that extends in a radial direction with respect to the axis and that forms a blade shape, an inner shroud provided on a radial inner side of the blade body, and an outer shroud provided on a radial outer side of the blade body. The blade body of the stator blade is disposed inside a combustion gas passage through which the combustion gas passes. The inner shroud defines a radial inner side edge of the combustion gas passage. The outer shroud defines a radial outer side edge of the combustion gas passage.

The stator blade of the gas turbine is exposed to a high-temperature combustion gas. For this reason, the stator blade is generally cooled by air or the like.

For example, a plurality of cooling air spaces through which cooling air passes are formed in the blade body of the stator blade disclosed in PTL 1 below. All of the plurality of cooling air spaces extend in a blade height direction that is a radial direction with respect to the axis. Among the plurality of cooling air spaces, a plurality of trailing end cooling passages that extend to a trailing edge of the blade body are formed in a trailing end space on the farthest side of the trailing edge. In the trailing end space, a plurality of pins and a plurality of ribs that partition the trailing end space in the blade height direction are disposed. The plurality of pins protrude from a positive pressure-side inner surface or a negative pressure-side inner surface that defines the trailing end space. In addition, the plurality of ribs also protrude from the positive pressure-side inner surface or the negative pressure-side inner surface that define the trailing end space. In addition, among the plurality of cooling air spaces, a tubular insert is inserted in an adjacent space in contact with an edge on a side of the leading edge of the trailing end space. A through-hole through which cooling air can be ejected from an inner peripheral side to an outer peripheral side is formed in the tubular insert.

In addition, for example, a plurality of cooling air spaces through which cooling air passes are also formed in a blade body of a stator blade described in PTL 2 below. All of the plurality of cooling air spaces extend in a blade height direction that is a radial direction with respect to the axis. Among the plurality of cooling air spaces, a plurality of pins are disposed in a trailing end space on the farthest side of a trailing edge. The plurality of pins are joined to a positive pressure-side inner surface and to a negative pressure-side inner surface that define the trailing end space. In addition, among the plurality of cooling air spaces, a tubular insert is inserted in an adjacent space in contact with an edge on a side of a leading edge of the trailing end space. A through-hole through which the cooling air can be ejected from an inner peripheral side to an outer peripheral side is formed in the tubular insert.

### CITATION LIST

### Patent Literature

[PTL 1] Japanese Unexamined Patent Application Publication No. 10-306705 FIG. 5
[PTL 2] Japanese Patent No. 6,353,131

### SUMMARY OF INVENTION

### Technical Problem

In the techniques described in PTL 1 and PTL 2, the plurality of pins are provided in the trailing end space, so that heat exchange between a wall surface that defines the trailing end space and the cooling air in the trailing end space can be efficiently performed. In addition, as in the technique described in PTL 2, in a case where the positive pressure-side inner surface and the negative pressure-side inner surface that define the trailing end space are connected to each other by the plurality of pins in the trailing end space, the rigidity of a portion of the stator blade including the trailing end space can be increased.

In addition, in the techniques described in PTL 1 and PTL 2, the tubular insert is inserted into the adjacent space in contact with the edge on the side of the leading edge of the trailing end space, so that the positive pressure-side inner surface and the negative pressure-side inner surface that define the adjacent space are not connected to each other by a pin or the like. For this reason, the rigidity of a portion around the adjacent space in the stator blade is lower than the rigidity of a portion around the trailing end space in the stator blade.

During the operation of the gas turbine, the pressure inside the cooling air space of the blade body is higher than the pressure on the outer side of the blade body. For this reason, during the operation of the gas turbine, a force that causes a blade surface of the blade body to be inflated outward acts on the blade body due to a pressure difference between the inside and the outside of the blade body. A phenomenon in which the force causes the blade surface to bulge and be creep-deformed is called bulging.

In the blade body of the stator blade, a bulging phenomenon is likely to occur in a portion having low rigidity. In a case where the bulging phenomenon occurs, not only the aerodynamic performance of the stator blade is reduced, but also the durability of the stator blade is reduced.

Therefore, an object of the present disclosure is to provide a technique capable of improving bulging strength of a stator blade and suppressing a decrease in aerodynamic performance and durability of the stator blade.

### Solution to Problem

According to an aspect of the invention, in order to achieve the above-described object, there is provided a stator blade included in a gas turbine, the stator blade including a blade body of which a shape forms a blade shape in a cross section and that extends in a blade height direction having a direction component perpendicular to the cross section.

The blade body includes a leading edge and a trailing edge that extend in the blade height direction, a positive pressure surface and a negative pressure surface that extend in the blade height direction and that connect the leading edge and the trailing edge, a trailing end space and an adjacent space that are positioned between the leading edge and the trailing edge and between the positive pressure surface and the negative pressure surface, and a plurality of trailing end cooling passages that penetrate from the trailing end space to the trailing edge. The adjacent space is positioned further on a side of the leading edge than the trailing end space. An edge of the trailing end space on the side of the leading edge is open and communicates with the trailing end space. Both the adjacent space and the trailing end space are each defined by an inner wall surface. Both the inner wall surface of the adjacent space and the inner wall surface of the trailing end space each include a positive pressure-side inner wall surface that extends along the positive pressure surface, and a negative pressure-side inner wall surface that extends along the negative pressure surface and that is separated from the positive pressure-side inner wall surface toward a side of the negative pressure surface. The positive pressure-side inner wall surface of the adjacent space and the positive pressure-side inner wall surface of the trailing end space are connected to each other. The negative pressure-side inner wall surface of the adjacent space and the negative pressure-side inner wall surface of the trailing end space are connected to each other. A plurality of partition ribs, which are aligned in the blade height direction and partition the trailing end space in the blade height direction, and a plurality of pins are disposed in the trailing end space.

All of the plurality of pins are joined to the positive pressure-side inner wall surface of the trailing end space and to the negative pressure-side inner wall surface of the trailing end space. At least one partition rib among the plurality of partition ribs forms an extending partition rib that extends to an interior of the adjacent space and that is joined to the inner wall surface which defines the adjacent space.

In the present aspect, the positive pressure-side inner wall surface and the negative pressure-side inner wall surface that define the trailing end space are joined to each other by the plurality of pins. For this reason, the rigidity around the trailing end space in the blade body is higher than the rigidity around the adjacent space in the blade body. In other words, the rigidity around the adjacent space in the blade body is lower than the rigidity around the trailing end space in the blade body. A bulging phenomenon is likely to occur in a portion in the blade body having low rigidity. In a case where the bulging phenomenon occurs, not only the aerodynamic performance of the stator blade is reduced, but also the durability of the stator blade is reduced. In particular, in the vicinity of a boundary between a portion of the blade body having low rigidity and a portion of the blade body having high rigidity, high stress is generated due to deformation caused by the bulging phenomenon. That is, in the vicinity of the boundary between the adjacent space and the trailing end space, high stress is generated due to the deformation caused by the bulging phenomenon.

Therefore, in the present aspect, at least one partition rib among the plurality of partition ribs disposed in the trailing end space extends to the interior of the adjacent space, and the rigidity in the vicinity of the boundary between the adjacent space and the trailing end space is increased. As a result, in the present aspect, the occurrence of the bulging phenomenon is suppressed, and the deformation in the vicinity of the boundary between the adjacent space and the trailing end space is suppressed.

Therefore, in the present aspect, the bulging strength of the stator blade can be improved, and a decrease in aerodynamic performance and durability of the stator blade due to the occurrence of a bulging phenomenon can be suppressed.

According to an aspect of the invention, in order to achieve the above-described object, there is provided a gas turbine including the stator blade according to the aspect, a rotor that rotates about an axis, and a casing that covers an outer peripheral side of the rotor.

The stator blade is fixed to an inner peripheral surface of the casing.

### Advantageous Effects of Invention

According to one aspect of the present disclosure, the bulging strength of a stator blade can be improved, and a decrease in aerodynamic performance and durability of the stator blade can be suppressed.

### BRIEF DESCRIPTION OF DRAWINGS

FIG. 1 is a schematic cross-sectional view of a gas turbine according to an embodiment of the present disclosure.

FIG. 2 is a perspective view of a stator blade in the embodiment according to the present disclosure.

FIG. 3 is a cross-sectional view taken along line III-III in FIG. 2 (a longitudinal cross-sectional view of a main portion of the stator blade).

FIG. 4 is a cross-sectional view taken along line IV-IV in FIG. 3 (a lateral cross-sectional view of a blade body).

FIG. 5 is an enlarged view of a V portion in FIG. 4 (a lateral cross-sectional view of a main portion of the blade body).

FIG. 6 is a vertical cross-sectional view of a main portion of a stator blade in a modification example of the embodiment according to the present disclosure.

FIG. 7 is a lateral cross-sectional view of a main portion of a blade body according to another modification example of the embodiment of the present disclosure.

### DESCRIPTION OF EMBODIMENTS

Hereinafter, embodiments of a stator blade according to the present disclosure and a gas turbine including the stator blade will be described in detail with reference to the drawings.

### Embodiment of Gas Turbine

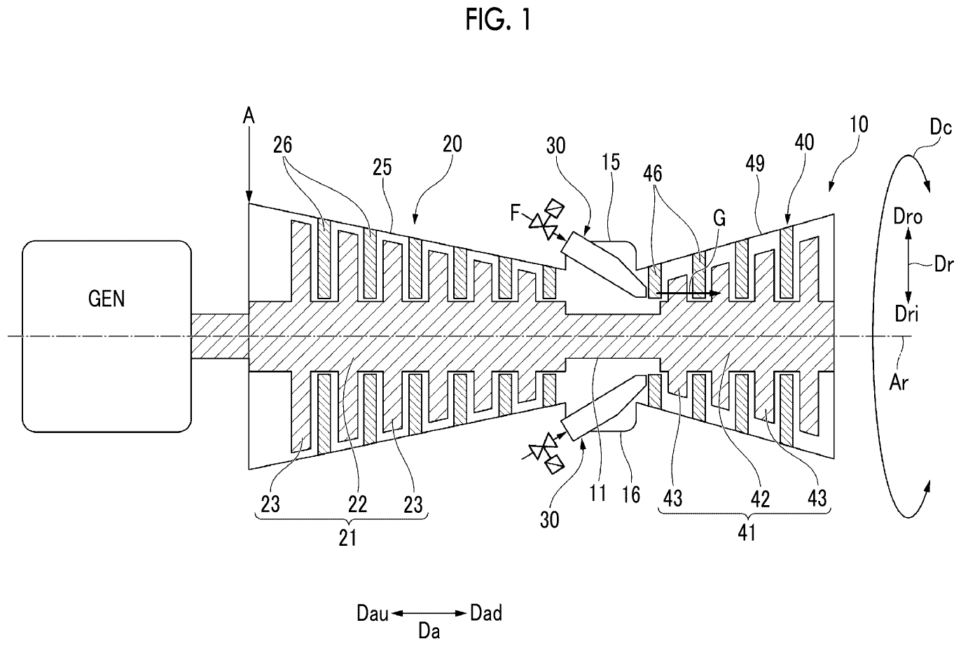

An embodiment of a gas turbine will be described with reference to FIG. 1.

As illustrated in FIG. 1, a gas turbine 10 of the present embodiment includes a compressor 20 that compresses air A, a combustor 30 that combusts a fuel F in the air A compressed by the compressor 20 to generate a combustion gas G, and a turbine 40 driven by the combustion gas G.

The compressor 20 includes a compressor rotor 21 that rotates around an axis Ar, a compressor casing 25 that covers the compressor rotor 21, and a plurality of stator blade rows 26. The turbine 40 includes a turbine rotor 41 that rotates around the axis Ar, a turbine casing 45 that covers the turbine rotor 41, and a plurality of stator blade rows 46. Hereinafter, an extending direction of the axis Ar will be referred to as an axial direction Da, a circumferential direction around the axis Ar will be simply referred to as a circumferential direction De, and a direction perpendicular to the axis Ar will be referred to as a radial direction Dr. In addition, one side in the axial direction Da will be referred to as an axial upstream side Dau, and a side opposite thereto will be referred to as an axial downstream side Dad. In addition, a side closer to the axis Ar in the radial direction Dr will be referred to as a radial inner side Dri, and a side opposite thereto will be referred to as a radial outer side Dro.

The compressor 20 is disposed on the axial upstream side Dau with respect to the turbine 40.

The compressor rotor 21 and the turbine rotor 41 are positioned on the same axis Ar and are connected to each other to form a gas turbine rotor 11. For example, a rotor of a generator GEN is connected to the gas turbine rotor 11. The gas turbine 10 further includes an intermediate casing 16. The intermediate casing 16 is disposed between the compressor casing 25 and the turbine casing 45 in the axial direction Da. The compressor casing 25, the intermediate casing 16, and the turbine casing 45 are connected to each other to form a gas turbine casing 15.

The compressor rotor 21 includes a rotor shaft 22 extending in the axial direction Da around the axis Ar, and a plurality of rotor blade rows 23 attached to the rotor shaft 22. The plurality of rotor blade rows 23 are aligned in the axial direction Da. Each of the rotor blade rows 23 is configured by a plurality of rotor blades aligned in the circumferential direction Dc. One stator blade row 26 of the plurality of stator blade rows 26 is disposed on the axial downstream side Dad of each of the plurality of rotor blade rows 23. Each of the stator blade rows 26 is provided inside the compressor casing 25. Each of the stator blade rows 26 is configured by a plurality of stator blades aligned in the circumferential direction De.

The turbine rotor 41 includes a rotor shaft 42 extending in the axial direction Da and having the axis Ar as a center, and a plurality of rotor blade rows 43 attached to the rotor shaft 42. The plurality of rotor blade rows 43 are aligned in the axial direction Da. Each of the rotor blade rows 43 is configured by a plurality of rotor blades aligned in the circumferential direction De. One stator blade row 46 among the plurality of stator blade rows 46 is disposed on the axial upstream side Dau of each of the plurality of the rotor blade rows. Each of the stator blade rows 46 is provided inside the turbine casing 45. Each of the stator blade rows 46 is configured by a plurality of stator blades aligned in the circumferential direction De.

The combustor 30 is attached to the intermediate casing 16.

The compressor 20 compresses the air A to generate compressed air. The compressed air flows into the combustor 30. The fuel F is supplied to the combustor 30. In the combustor 30, the fuel F is combusted in the compressed air, and the combustion gas G of which the temperature and the pressure are high is generated. The combustion gas G is sent from the combustor 30 to an annular combustion gas passage 49 in the turbine casing 45. The combustion gas G rotates the turbine rotor 41 while flowing through the inside of the combustion gas passage 49 toward the axial downstream side Dad. The rotor of the generator GEN connected to the gas turbine rotor 11 is rotated by the rotation of the turbine rotor 41. As a result, the generator GEN generates electricity.

Hereinafter, embodiments and modification examples related to the stator blade that configures the first-stage stator blade row 46 in the turbine 40 will be described.

### Embodiment of Stator Blade

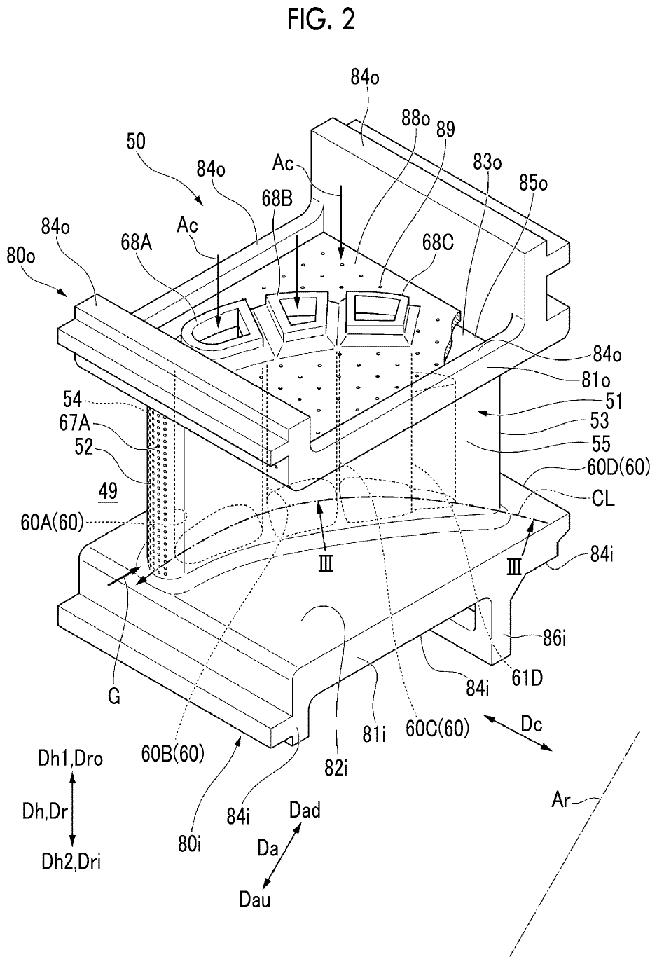

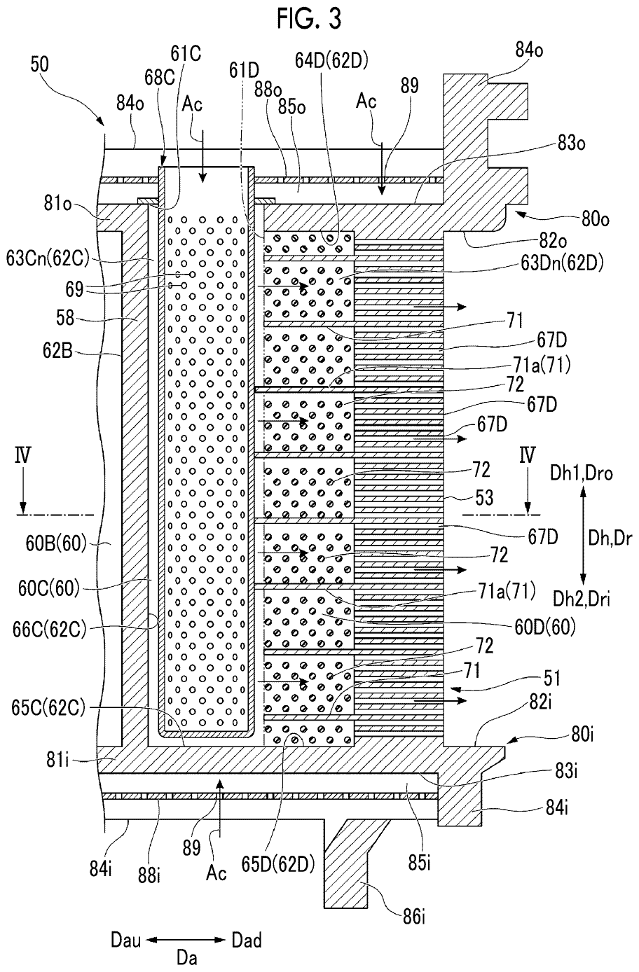

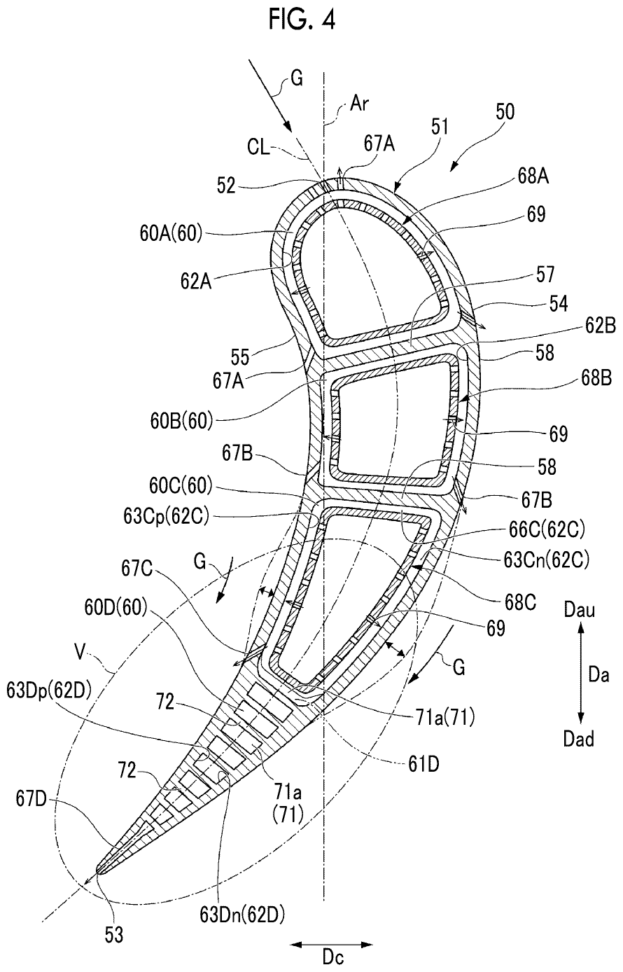

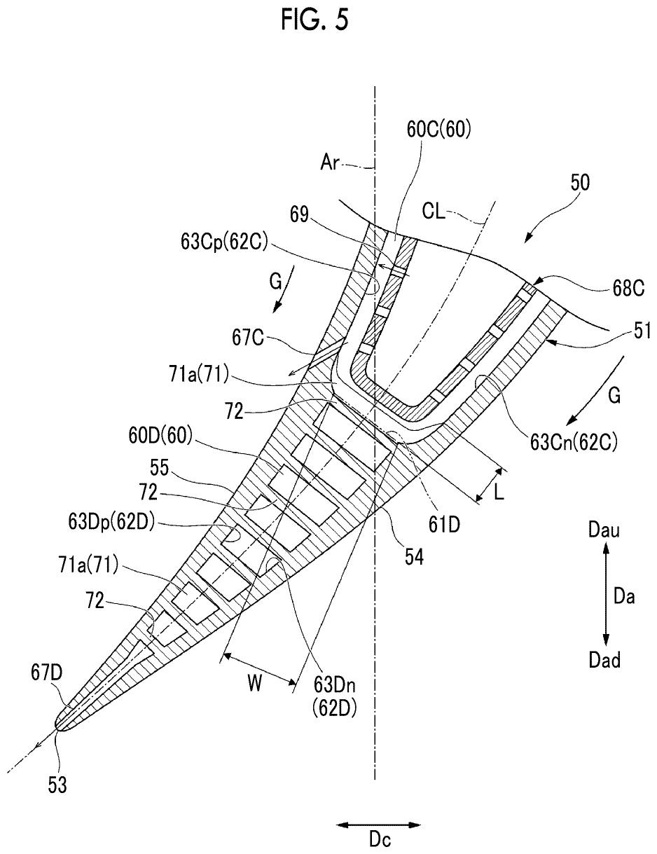

An embodiment of the stator blade will be described with reference to FIGS. 2 to 5, FIG. 2 is a perspective view of the stator blade in the present embodiment. FIG. 3 is a cross-sectional view taken along line III-III in FIG. 2 (a longitudinal cross-sectional view of a main portion of the stator blade). FIG. 4 is a cross-sectional view taken along line IV-IV in FIG. 3 (a lateral cross-sectional view of a blade body). FIG. 5 is an enlarged view of a portion V in FIG. 4 (a lateral cross-sectional view of a main portion of the blade body).

As illustrated in FIGS. 2 to 4, a stator blade 50 of the present embodiment includes a blade body 51, an inner shroud 80i, an outer shroud 800, an inner impingement plate 88i, an outer impingement plate 88o, a first insert 68A, a second insert 68B, and a third insert 68C.

The blade body 51 has a shape that forms a blade shape in a cross section, and extends in a blade height direction Dh having a direction component perpendicular to the cross section. The outer shroud 800 is provided in an end on one side in the blade height direction Dh in the blade body 51. The inner shroud 80i is provided in an end on the other side in the blade height direction Dh in the blade body 51. The blade body 51, the inner shroud 80i, and the outer shroud 800 are integrally formed by casting or the like.

The blade height direction Dh is the radial direction Dr in a state where the stator blade 50 is attached to the turbine casing 45. In addition, a blade height first side Dh1 on one side in the blade height direction Dh is the radial outer side Dro, and a blade height second side Dh2 on the other side in the blade height direction Dh is the radial inner side Dri. For this reason, the outer shroud 800 is provided on the radial outer side Dro of the blade body 51, and the inner shroud 80i is provided on the radial inner side Dri of the blade body 51. Therefore, in the present embodiment, the blade height direction Dh may be referred to as the radial direction Dr, the blade height first side Dh1 may be referred to as the radial outer side Dro, and the blade height second side Dh2 may be referred to as the radial inner side Dri.

As illustrated in FIGS. 2 to 4, a blade surface that is an outer surface of the blade body 51 includes a leading edge 52, a trailing edge 53, a negative pressure surface 54 that is a convex surface, and a positive pressure surface 55 that is a concave surface. The negative pressure surface 54 and the positive pressure surface 55 are surfaces connecting the leading edge 52 and the trailing edge 53. The leading edge 52, the trailing edge 53, the negative pressure surface 54, and the positive pressure surface 55 all extend in the radial direction Dr that is the blade height direction Dh. The leading edge 52 is positioned on the axial upstream side Dau with respect to the trailing edge 53 in a state where the stator blade 50 is attached to the turbine casing 45. In addition, in a state where the stator blade 50 is attached to the turbine casing 45, the negative pressure surface 54 faces one side in the circumferential direction Dc, and the positive pressure surface 55 faces the other side in the circumferential direction Dc. The blade body 51 is disposed in the combustion gas passage 49 of the turbine 40 described with reference to FIG. 1.

The blade body 51 includes a plurality of cooling air spaces 60 that extend in the blade height direction Dh (the radial direction Dr) in the blade body 51. The plurality of cooling air spaces 60 are aligned from the axial upstream side Dau toward the axial downstream side Dad along a camber line CL of the blade body 51. Here, among the plurality of cooling air spaces 60, the cooling air space 60 on the most axial upstream side Dau is referred to as a first space 60A, the cooling air space 60 adjacent to the first space 60A on the axial downstream side Dad is referred to as a second space 60B, the cooling air space 60 adjacent to the second space 60B on the axial downstream side Dad is referred to as a third space 60C, and the cooling air space 60 adjacent to the third space 60C on the axial downstream side Dad is referred to as a fourth space 60D. The first space 60A and the second space 60B are partitioned by a first partition wall 57 that extends in a direction substantially perpendicular to the camber line CL. In addition, the second space 60B and the third space 60C are partitioned by a second partition wall 58 that extends in a direction substantially perpendicular to the camber line CL. The first insert 68A is disposed in the first space 60A, the second insert 68B is disposed in the second space 60B, and the third insert 68C is disposed in the third space 60C.

The inner shroud 80i defines an edge on the radial inner side Dri of the annular combustion gas passage 49. In addition, the outer shroud 800 defines an edge on the radial outer side Dro of the annular combustion gas passage 49.

The inner shroud 80i includes a shroud body 81i, a peripheral wall 84i, and a retainer 86i.

The shroud body 81i is a quadrangular plate-shaped member that extends in a direction including a direction component in a direction perpendicular to the radial direction Dr that is the blade height direction Dh. The shroud body 81i includes a gas path surface 82i and a counter gas path surface 83i. The gas path surface 82i is a surface facing the radial outer side Dro that is the blade height first side Dh1 and with which the combustion gas G comes into contact. The counter gas path surface 83i is a surface facing the radial inner side Dri that is the blade height second side Dh2. The counter gas path surface 83i is in a back-to-back relationship with the gas path surface 82i.

The peripheral wall 84i is a wall that protrudes from the shroud body 81i to the radial inner side Dri along an outer peripheral edge of the shroud body 81i. In the inner shroud 80i, a cavity 85i recessed toward the radial outer side Dro is formed by the shroud body 81i and the peripheral wall 84i.

The retainer 86i is formed on the radial inner side Dri of the peripheral wall 84i. The retainer 86i is connected to an end on the radial outer side Dro of an inner cover (not illustrated) fixed to the gas turbine casing 15, and serves to support a portion of the stator blade 50 on the radial inner side Dri to the inner cover.

The outer shroud 80o has essentially the same configuration as the configuration of the inner shroud 80i. Therefore, similarly to the inner shroud 80i, the outer shroud 80o also includes a shroud body 81o and a peripheral wall 84o. However, the outer shroud 80o does not have a portion corresponding to the retainer 86i of the inner shroud 80i. Similarly to the shroud body 81i of the inner shroud 80i, the shroud body 81o of the outer shroud 80o also has a quadrangular plate shape and includes a gas path surface 82o and a counter gas path surface 83o. The gas path surface 82o of the outer shroud 80o is a surface facing the radial inner side Dri that is the blade height second side Dh2 and with which the combustion gas G comes into contact. The counter gas path surface 83o of the outer shroud 80o is a surface facing the radial outer side Dro that is the blade height first side Dh1.

The peripheral wall 84o is a wall that protrudes from the shroud body 81o to the radial outer side Dro along the outer peripheral edge of the shroud body 81o. A cavity 85o recessed toward the radial inner side Dri by the shroud body 81o and the peripheral wall 84o is formed in the outer shroud 80o. A portion of the peripheral wall 84o serves to attach the stator blade 50 to an inner peripheral side of the turbine casing 45.

The inner impingement plate 88i partitions the cavity 85i of the inner shroud 80i into two spaces in the blade height direction Dh. A plurality of impingement holes 89 penetrating in the blade height direction Dh are formed in the inner impingement plate 88i.

Cooling air Ac that has flowed into the cavity 85i of the inner shroud 80i is ejected to the radial outer side Dro from the plurality of impingement holes 89 of the inner impingement plate 88i, collides with the counter gas path surface 83i of the inner shroud 80i, and performs impingement cooling on the counter gas path surface 83i. The cooling air Ac that has performed impingement cooling on the counter gas path surface 83i is ejected into the combustion gas passage 49 through, for example, a passage (not illustrated), and performs film cooling on the gas path surface 82i or the like.

The outer impingement plate 88o partitions the cavity 85o of the outer shroud 80o into two spaces in the blade height direction Dh. The plurality of impingement holes 89 penetrating in the blade height direction Dh are formed in the outer impingement plate 88o.

The cooling air Ac that has flowed into the cavity 85o of the outer shroud 80o is ejected to the radial inner side Dri from the plurality of impingement holes 89 of the outer impingement plate 88o, collides with the counter gas path surface 83o of the outer shroud 80o, and performs impingement cooling on the counter gas path surface 83o. The cooling air Ac that has performed impingement cooling on the counter gas path surface 83o is ejected to the combustion gas passage 49 through, for example, a passage (not illustrated), and performs film cooling on the gas path surface 82o or the like.

As illustrated in FIGS. 3 and 4, the third space 60C is closed at an end on the radial inner side Dri that is the blade height second side Dh2, and is open at an end on the radial outer side Dro that is the blade height first side Dh1. An end on the radial inner side Dri of the blade body 51 forms a portion of the counter gas path surface 83i of the inner shroud 80i, and an end on the radial outer side Dro of the blade body 51 forms a portion of the counter gas path surface 83o of the outer shroud 80o. For this reason, an opening 61C of the third space 60C is open in the counter gas path surface 83o of the outer shroud 80o. A plurality of third blade surface cooling passages 67C penetrating from an inner wall surface 62C defining the third space 60C to the blade surface of the blade body 51 are formed in the blade body 51.

Similarly to the third space 60C described with reference to FIGS. 3 and 4, the first space 60A and the second space 60B are closed at the end on the radial inner side Dri that is the blade height second side Dh2, and are open at the end on the radial outer side Dro that is the blade height first side Dh1. An opening of the first space 60A and an opening of the second space 60B are open in the counter gas path surface 83o of the outer shroud 80o, similar to the opening 61C of the third space 60C. A plurality of first blade surface cooling passages 67A penetrating from an inner wall surface 62A defining the first space 60A to the blade surface of the blade body 51 are formed in the blade body 51. Further, a plurality of second blade surface cooling passages 67B penetrating from an inner wall surface 62B defining the second space 60B to the blade surface of the blade body 51 are formed in the blade body 51.

As illustrated in FIGS. 3 and 4, the third insert 68C disposed in the third space 60C has a tubular shape and extends in the radial direction Dr. An end of the third insert 68C on the radial inner side Dri is closed, and an end of the third insert 68C on the radial outer side Dro is open. Although almost the entire third insert 68C is positioned inside the third space 60C, a portion of the third insert 68C on the radial outer side Dro protrudes from the third space 60C to the radial outer side Dro, and the end of the third insert 68C on the radial outer side Dro is positioned further on the radial outer side Dro than the outer impingement plate 88o is. For this reason, the cooling air Ac can flow into the third insert 68C from the opening of the third insert 68C. A plurality of impingement holes 69 penetrating from an inner peripheral side to an outer peripheral side are formed in the third insert 68C having a tubular shape. For this reason, the cooling air Ac that has flowed into the third insert 68C is ejected from the plurality of impingement holes 69, collides with the inner wall surface 62C defining the third space 60C, and performs impingement cooling on the inner wall surface 62C. A portion of the cooling air Ac that has performed impingement cooling on the inner wall surface 62C defining the third space 60C is ejected to the combustion gas passage 49 through the plurality of third blade surface cooling passages 67C described above, and performs film cooling on the blade surface.

The first insert 68A disposed in the first space 60A and the second insert 68B disposed in the second space 60B have substantially the same configuration as the configuration of the third insert 68C described with reference to FIGS. 3 and 4. That is, similarly to the third insert 68C, the first insert 68A and the second insert 68B have a tubular shape and extend in the radial direction Dr. Ends of the first insert 68A and the second insert 68B on the radial inner side Dri are closed, and Ends of the first insert 68A and the second insert 68B on the radial outer side Dro are open. Although almost the entire first insert 68A is positioned inside the first space 60A, a portion of the first insert 68A on the radial outer side Dro protrudes from the third space 60C to the radial outer side Dro, and the end of the first insert 68A on the radial outer side Dro is positioned further on the radial outer side Dro than the outer impingement plate 88o is. For this reason, the cooling air Ac can flow into the first insert 68A from the opening of the first insert 68A. The plurality of impingement holes 69 penetrating from the inner peripheral side to the outer peripheral side are also formed in the first insert 68A having a tubular shape. For this reason, the cooling air Ac that has flowed into the first insert 68A is ejected from the plurality of impingement holes 69, collides with the inner wall surface 62A defining the first space 60A, and performs impingement cooling on the inner wall surface 62A. The cooling air Ac that has performed impingement cooling on the inner wall surface 62A defining the first space 60A is ejected to the combustion gas passage 49 through the plurality of first blade surface cooling passages 67A described above, and performs film cooling on the blade surface. In addition, although almost the entire second insert 68B is positioned inside the second space 60B, a portion of the second insert 68B on the radial outer side Dro protrudes from the second space 60B to the radial outer side Dro, and the end of the second insert 68B on the radial outer side Dro is positioned further on the radial outer side Dro than the outer impingement plate 88o is. For this reason, the cooling air Ac can flow into the second insert 68B from the opening of the second insert 68B. The plurality of impingement holes 69 penetrating from the inner peripheral side to the outer peripheral side are also formed in the second insert 68B having a tubular shape. For this reason, the cooling air Ac that has flowed into the second insert 68B is ejected from the plurality of impingement holes 69, collides with the inner wall surface 62B defining the second space 60B, and performs impingement cooling on the inner wall surface 62B. The cooling air Ac that has performed impingement cooling on the inner wall surface 62B defining the second space 60B is ejected to the combustion gas passage 49 through the plurality of second blade surface cooling passages 67B described above, and performs film cooling on the blade surface.

The fourth space 60D is positioned on the most axial downstream side Dad among the plurality of cooling air spaces 60. For this reason, hereinafter, the fourth space 60D is referred to as a trailing end space 60D. In addition, the third space 60C is adjacent to the axial upstream side Dau of the trailing end space 60D. For this reason, hereinafter, the third space 60C is referred to as an adjacent space 60C.

The trailing end space 60D is closed at the end on the radial inner side Dri that is the blade height second side Dh2 and at the end on the radial outer side Dro that is the blade height first side Dh1. In addition, the edge (the edge on the side of the leading edge 52) on the axial upstream side Dau of the trailing end space 60D is open and communicates with the adjacent space 60C. The inner wall surface 62D defining the trailing end space 60D includes a blade height first-side inner wall surface 64D, a blade height second-side inner wall surface 65D, a positive pressure-side inner wall surface 63Dp, and a negative pressure-side inner wall surface 63Dn. The blade height first-side inner wall surface 64D faces the blade height second side Dh2 and defines an edge of the trailing end space 60D on the blade height first side Dh1. The blade height second-side inner wall surface 65D faces the blade height first side Dh1 and defines an edge of the trailing end space 60D on the blade height second side Dh2. The positive pressure-side inner wall surface 63Dp faces a side of the negative pressure surface 54, extends along the positive pressure surface 55, and defines an edge on a side of the positive pressure surface 55 of the trailing end space 60D. An edge of the positive pressure-side inner wall surface 63Dp on the blade height first side Dh1 is connected to the blade height first-side inner wall surface 64D. In addition, the edge of the positive pressure-side inner wall surface 63Dp on the blade height second side Dh2 is connected to the blade height second-side inner wall surface 65D. The negative pressure-side inner wall surface 63Dn faces the side of the positive pressure surface 55, extends along the negative pressure surface 54, is separated from the positive pressure-side inner wall surface 63Dp toward the side of the negative pressure surface 54, and defines the edge on the side of the negative pressure surface 54 of the trailing end space 60D. An edge of the negative pressure-side inner wall surface 63Dn on the blade height first side Dh1 is connected to the blade height first-side inner wall surface 64D. In addition, an edge of the negative pressure-side inner wall surface 63Dn on the blade height second side Dh2 is connected to the blade height second-side inner wall surface 65D. Further, an edge of the negative pressure-side inner wall surface 63Dn on the axial downstream side Dad is connected to an edge of the positive pressure-side inner wall surface 63Dp on the axial downstream side Dad.

A plurality of trailing end cooling passages 67D penetrating the combustion gas passage from the trailing end space 60D are formed in the blade body 51. The trailing end cooling passage 67D penetrates from a boundary between the edge of the negative pressure-side inner wall surface 63Dn on the axial downstream side Dad and the edge of the positive pressure-side inner wall surface 63Dp on the axial downstream side Dad to the trailing edge 53 of the blade body 51. The plurality of trailing end cooling passages 67D are aligned in the blade height direction Dh.

A plurality of partition ribs 71 that are aligned in the blade height direction Dh and that partition the trailing end space 60D in the blade height direction Dh, and a plurality of pins 72 having a cylindrical or polygonal prism shape are disposed in the trailing end space 60D.

The plurality of partition ribs 71 extend in a direction substantially perpendicular to the blade height direction Dh and are joined to the positive pressure-side inner wall surface 63Dp and to the negative pressure-side inner wall surface 63Dn. The plurality of pins 72 extend in a direction substantially perpendicular to the camber line CL and are joined to the positive pressure-side inner wall surface 63Dp and to the negative pressure-side inner wall surface 63Dn.

At least one partition rib 71 among the plurality of partition ribs 71 forms an extending partition rib 71a that extends to an interior of the adjacent space 60C. Specifically, the extending partition rib 71a is disposed at a position of 30% to 70% of a dimension of the trailing end space 60D in the blade height direction Dh from the blade height second-side inner wall surface 65D defining the trailing end space 60D. That is, the extending partition rib 71a is disposed in the vicinity of a central portion of the blade body 51 in the blade height direction Dh.

The inner wall surface 62C defining the adjacent space 60C that is the third space 60C includes a blade height second-side inner wall surface 65C, a positive pressure-side inner wall surface 63Cp, a negative pressure-side inner wall surface 63Cn, and a second partition wall surface 66C that is the surface of the second partition wall 58 facing the axial downstream side Dad. The blade height second-side inner wall surface 65C faces the blade height first side Dh1 and defines an edge of the adjacent space 60C on the blade height second side Dh2. An edge of the blade height second-side inner wall surface 65C on the axial downstream side Dad is connected to an edge of the blade height second-side inner wall surface 65D, which defines the trailing end space 60D, on the axial upstream side Dau. The positive pressure-side inner wall surface 63Cp faces the side of the negative pressure surface 54, extends along the positive pressure surface 55, and defines an edge on the side of the positive pressure surface 55 of the trailing end space 60D. An edge of the positive pressure-side inner wall surface 63Cp on the blade height second side Dh2 is connected to the blade height second-side inner wall surface 65C. An edge of the positive pressure-side inner wall surface 63Cp on the axial upstream side Dau is connected to the second partition wall surface 66C. An edge of the positive pressure-side inner wall surface 63Cp on the axial downstream side Dad is connected to an edge of the positive pressure-side inner wall surface 63Dp, which defines the trailing end space 60D, on the axial upstream side Dau. The negative pressure-side inner wall surface 63Cn faces the side of the positive pressure surface 55, extends along the negative pressure surface 54 surface, is separated from the positive pressure-side inner wall surface 63Cp toward the side of the negative pressure surface 54, and defines the edge on the side of the negative pressure surface 54 of the adjacent space 60C. An edge of the negative pressure-side inner wall surface 63Cn on the blade height second side Dh2 is connected to the blade height second-side inner wall surface 65C. An edge of the negative pressure-side inner wall surface 63Cn on the axial upstream side Dau is connected to the second partition wall surface 66C. An edge of the negative pressure-side inner wall surface 63Cn on the axial downstream side Dad is connected to an edge of the negative pressure-side inner wall surface 63Dn, which defines the trailing end space 60D, on the axial upstream side Dau.

A portion of the extending partition rib 71a described above, which is present in the adjacent space 60C, is joined to the positive pressure-side inner wall surface 63Dp and to the negative pressure-side inner wall surface 63Cn of the inner wall surface 62C defining the adjacent space 60C. As illustrated in FIG. 5, an extension dimension L by which the extending partition rib 71a extends to the interior of the adjacent space 60C from the edge of the trailing end space 60D on the axial upstream side Dau (the edge on the side of the leading edge 52) is smaller than twice a boundary width W that is an interval between the positive pressure-side inner wall surface 63Dp and the negative pressure-side inner wall surface 63Dn in the edge on the side of the leading edge 52 in the trailing end space 60D. The edge on the side of the leading edge 52 in the trailing end space 60D is a boundary between the adjacent space 60C and the trailing end space 60D, and is an opening 61D on the side of the leading edge 52 in the trailing end space 60D. In addition, in the present embodiment, the edge on the side of the leading edge 52 in the trailing end space 60D is at a position of the edge on the side of the leading edge 52 in the pin 72, which is closest to the side of the leading edge 52, among the plurality of pins 72.

Another portion of the cooling air Ac which has been ejected from the third insert 68C disposed in the adjacent space 60C that is the third space 60C and which has performed impingement cooling on the inner wall surface 62C defining the adjacent space 60C flows into the trailing end space 60D from the opening 61D of the trailing end space 60D. The cooling air Ac that has flowed into the trailing end space 60D performs convection cooling in a process of flowing inside the trailing end space 60D, on the plurality of partition ribs 71, the plurality of pins 72, and the inner wall surface 62D defining the trailing end space 60D. The cooling air Ac flows into the plurality of trailing end cooling passages 67D. The cooling air Ac that has flowed into the trailing end cooling passage 67D performs convection cooling on the surface defining the trailing end space 60D in the process of flowing inside the trailing end space 60D. The cooling air Ac is ejected from the trailing edge 53 of the blade body 51 to the combustion gas passage 49.

As described above, the positive pressure-side inner wall surface 63Dp and the negative pressure-side inner wall surface 63Dn that define the trailing end space 60D are joined to each other by the plurality of pins 72 and partition ribs 71. On the other hand, since the third insert 68C is inserted into the adjacent space 60C adjacent to the trailing end space 60D, the positive pressure-side inner wall surface 63Cp and the negative pressure-side inner wall surface 63Cn defining the adjacent space 60C are not joined to each other by a pin or the like. For this reason, the rigidity around the adjacent space 60C in the blade body 51 is lower than the rigidity around the trailing end space 60D in the blade body 51. As described in the section “Technical Problem”, in a portion of the blade body 51 having low rigidity, a bulging phenomenon in which the blade surface is creep-deformed in a bulging form is likely to occur due to a pressure difference between the inside and the outside of the blade body 51 during the operation of the gas turbine. In a case where the bulging phenomenon occurs, the blade surface of the portion having low rigidity is deformed as indicated by a two-dot chain line in FIG. 4. In a case where the bulging phenomenon occurs, not only the aerodynamic performance of the stator blade 50 is reduced, but also the durability of the stator blade 50 is reduced. In particular, in the vicinity of a boundary between a portion of the blade body 51 having low rigidity and a portion of the blade body 51 having high rigidity, high stress is generated due to deformation caused by the bulging phenomenon. That is, in the vicinity of the boundary between the adjacent space 60C and the trailing end space 60D, high stress is generated due to the deformation caused by the bulging phenomenon. In addition, around the adjacent space 60C in the blade body 51, the amount of deformation caused by the bulging phenomenon increases in the vicinity of the central portion of the blade body 51 in the blade height direction Dh.

Therefore, in the present embodiment, among the plurality of partition ribs 71 disposed in the trailing end space 60D, the plurality of partition ribs 71 disposed in the vicinity of the central portion of the blade body 51 in the blade height direction Dh extend to the interior of the adjacent space 60C, and the rigidity is increased in the vicinity of the boundary between the adjacent space 60C and the trailing end space 60D and in the vicinity of the central portion of the blade body 51 in the blade height direction Dh. As a result, in the present embodiment, the occurrence of the bulging phenomenon is suppressed, and the deformation is suppressed in the vicinity of the boundary between the adjacent space 60C and the trailing end space 60D and in the vicinity of the central portion of the blade body 51 in the blade height direction Dh.

Therefore, in the present embodiment, the bulging strength of the stator blade 50 can be improved, and a decrease in aerodynamic performance and durability of the stator blade 50 due to the occurrence of a bulging phenomenon can be suppressed.

In the present embodiment, as described above, the extension dimension L by which the extending partition rib 71a extends to the interior of the adjacent space 60C from the edge of the trailing end space 60D on the side of the leading edge 52 is smaller than twice the boundary width W that is the interval between the positive pressure-side inner wall surface 63Dp of the trailing end space 60D and the negative pressure-side inner wall surface 63Dn of the trailing end space 60D in the edge on the side of the leading edge 52 in the trailing end space 60D. However, the extension dimension L of the extending partition rib 71a may be larger than twice the boundary width W. In this case, although the bulging strength of the blade body 51 increases as compared with a case where the extension dimension L of the extending partition rib 71a is set to be twice the boundary width W, the amount of increase in the bulging strength is smaller than the amount of increase in the extension dimension L. In addition, since the stator blade 50 is formed by casting, in a case where the extension dimension L of the extending partition rib 71a is increased, the difficulty of the casting increases accordingly. Therefore, in the present embodiment, the extension dimension L of the extending partition rib 7la is set to be smaller than twice the boundary width W.

### First Modification Example of Stator Blade

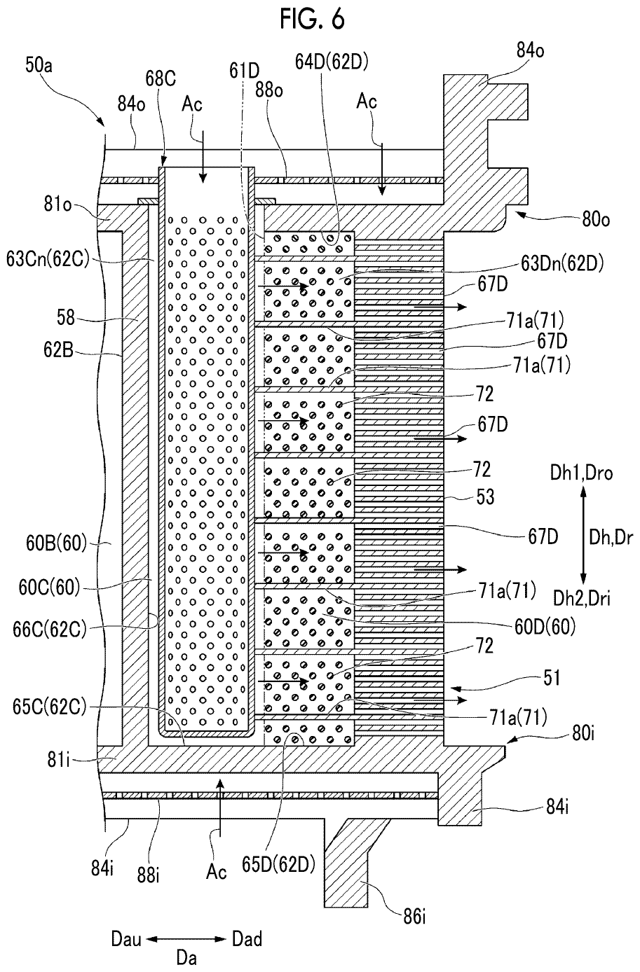

A first modification example of the stator blade according to the embodiment will be described with reference to FIG. 6.

In the stator blade 50 in the above-described embodiment, as described with reference to FIG. 3, among the plurality of partition ribs 71, the plurality of partition ribs 71 that are disposed at a position of 30% to 70% of the dimension of the trailing end space 60D in the blade height direction Dh from the blade height second-side inner wall surface 65D defining the trailing end space 60D form the extending partition rib 71a.

As illustrated in FIG. 6, in a stator blade 50a of the present modification example, all of the plurality of partition ribs 71 form the extending partition rib 71a. For this reason, in the present modification example, the overall rigidity can be increased in the vicinity of the boundary between the adjacent space 60C and the trailing end space 60D and in the blade height direction Dh of the blade body 51.

### Second Modification Example of Stator Blade

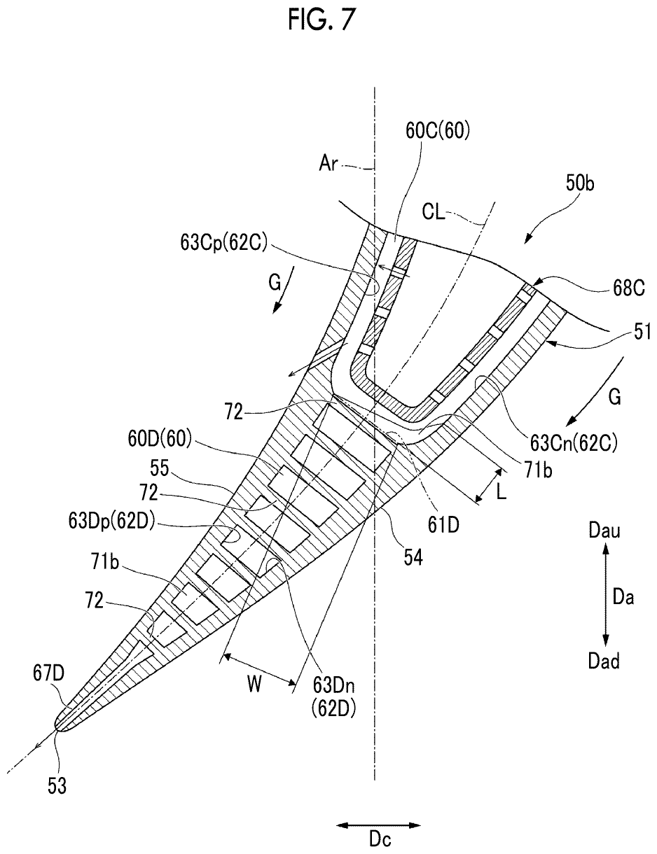

A second modification example of the stator blade according to the embodiment will be described with reference to FIG. 7.

In the stator blade 50 in the above-described embodiment, as described with reference to FIG. 5, a portion of the extending partition rib 71a, which is present in the adjacent space 60C, is joined to the positive pressure-side inner wall surface 63Cp and to the negative pressure-side inner wall surface 63Cn of the inner wall surface 62C defining the adjacent space 60C.

As illustrated in FIG. 7, in a stator blade 50b of the present modification example, a portion of the extending partition rib 71b, which is present in the adjacent space 60C, is joined only to the negative pressure-side inner wall surface 63Cn and is not joined to the positive pressure-side inner wall surface 63Cp, of the inner wall surface 62C that defines the adjacent space 60C.

From the inside of the adjacent space 60C, the static pressure received by the positive pressure-side inner wall surface 63Cp defining the adjacent space 60C and the static pressure received by the negative pressure-side inner wall surface 63Cn defining the adjacent space 60C are the same value. On the other hand, since the flow speed of the combustion gas G flowing along the negative pressure surface 54 outside the blade body 51 is higher than the flow speed of the combustion gas G flowing along the positive pressure surface 55 outside the blade body 51, the static pressure received by the negative pressure surface 54 from the outside of the blade body 51 is lower than the static pressure received by the positive pressure surface 55 from the outside of the blade body 51. Therefore, the pressure difference between the pressure in the adjacent space 60C and the pressure in the region along the negative pressure surface 54 outside the blade body 51 increases as compared with the pressure difference between the pressure in the adjacent space 60C and the pressure in the region along the positive pressure surface 55 outside the blade body 51. For this reason, even in a case where a bulging phenomenon occurs around the adjacent space 60C, the amount of deformation caused by the bulging phenomenon is larger on the side of the negative pressure surface 54 than on the side of the positive pressure surface 55.

Therefore, in the present modification example, a portion of the extending partition rib 71b, which is present in the adjacent space 60C, is joined only to the negative pressure-side inner wall surface 63Cn of the inner wall surface 62C defining the adjacent space 60C, and the rigidity is increased only in the vicinity of the boundary between the adjacent space 60C and the trailing end space 60D and on the side of the negative pressure surface 54.

In the present modification example, since the space occupied by the extending partition rib 71b in the adjacent space 60C is smaller than that in the above-described embodiment, the insertability of the third insert 68C into the adjacent space 60C and the degree of freedom in the layout of the third insert 68C in the adjacent space 60C can be increased.

The present modification example is a modification example of the stator blade 50 in the above-described embodiment. However, the present modification example may be applied to the stator blade 50a in the first modification example.

### Other Modification Examples of Stator Blade

All of the stator blades 50, 50a, and 50b in the above-described embodiment and each of the modification examples includes four spaces from the first space 60A to the fourth space 60D. However, the stator blade may have a larger number of spaces. In addition, in all of the stator blades 50, 50a, and 50b in the above-described embodiment and each of the modification examples, the insert is disposed in all of the spaces except for the trailing end space 60D that is the fourth space 60D. However, the insert may not be disposed in all of the spaces except for the trailing end space 60D.

All of the stator blades 50, 50a, and 50b in the above-described embodiment and each of the modification examples are stator blades that configure the first-stage stator blade row 46. However, the stator blade may be a stator blade that configures the stator blade row 46 on the axial downstream side Dad of the first-stage stator blade row 46.

In addition, the present disclosure is not limited to the above-described embodiment and each of the modification examples.

Various additions, changes, replacements, or partial deletions can be made within the scope that does not deviate from the conceptual idea and the gist of the present disclosure derived from the contents defined in the scope of the appended claims and the equivalent thereof.

### Additional Remarks

For example, the stator blade in the above-described embodiment and each of the modification examples is understood as follows.

(1) In a stator blade according to a first aspect, the stator blades 50, 50a, and 50b included in the gas turbine 10 include the blade body 51 of which a shape forms a blade shape in a cross section and that extends in the blade height direction Dh having a direction component perpendicular to the cross section.

The blade body 51 includes the leading edge 52 and the trailing edge 53 that extend in the blade height direction Dh, the positive pressure surface 55 and the negative pressure surface 54 that extend in the blade height direction Dh and that connect the leading edge 52 and the trailing edge 53, the trailing end space 60D and the adjacent space 60C that are positioned between the leading edge 52 and the trailing edge 53 and between the positive pressure surface 55 and the negative pressure surface 54, and the plurality of trailing end cooling passages 67D that penetrate from the trailing end space 60D to the trailing edge 53. The adjacent space 60C is positioned further on a side of the leading edge 52 than the trailing end space 60D is. An edge of the trailing end space 60D on the side of the leading edge 52 is open and communicates with the trailing end space 60D. Both the adjacent space 60C and the trailing end space 60D are each defined by the inner wall surfaces 62C and 62D. Both the inner wall surface 62C of the adjacent space 60C and the inner wall surface 62D of the trailing end space 60D each include the positive pressure-side inner wall surfaces 63Cp and 63Dp that extend along the positive pressure surface 55, and the negative pressure-side inner wall surfaces 63Cn and 63Dn that extend along the negative pressure surface 54 and that are separated from the positive pressure-side inner wall surfaces 63Cp and 63Dp toward a side of the negative pressure surface 54. The positive pressure-side inner wall surface 63Cp of the adjacent space 60C and the positive pressure-side inner wall surface 63Dp of the trailing end space 60D are connected to each other. The negative pressure-side inner wall surface 63Cn of the adjacent space 60C and the negative pressure-side inner wall surface 63Dn of the trailing end space 60D are connected to each other. The plurality of partition ribs 71, which are aligned in the blade height direction Dh and partition the trailing end space 60D in the blade height direction Dh, and the plurality of pins 72 are disposed in the trailing end space 60D. All of the plurality of pins 72 are joined to the positive pressure-side inner wall surface 63Dp of the trailing end space 60D and to the negative pressure-side inner wall surface 63Dn of the trailing end space 60D. The at least one partition rib 71 among the plurality of partition ribs 71 forms the extending partition ribs 71a and 71b that extend to an interior of the adjacent space 60C and that are joined to the inner wall surface 62C defining the adjacent space 60C.

In the present aspect, the positive pressure-side inner wall surface 63Dp and the negative pressure-side inner wall surface 63Dn that define the trailing end space 60D are joined by the plurality of pins 72. For this reason, the rigidity around the trailing end space 60D in the blade body 51 is higher than the rigidity around the adjacent space 60C in the blade body 51. In other words, the rigidity around the adjacent space 60C in the blade body 51 is lower than the rigidity around the trailing end space 60D in the blade body 51. In the blade body 51, a bulging phenomenon is likely to occur in a portion having low rigidity. In a case where the bulging phenomenon occurs, not only the aerodynamic performance of the stator blade 50 is reduced, but also the durability of the stator blade 50 is reduced. In particular, in the vicinity of a boundary between a portion of the blade body 51 having low rigidity and a portion of the blade body 51 having high rigidity, high stress is generated due to deformation caused by the bulging phenomenon. That is, in the vicinity of the boundary between the adjacent space 60C and the trailing end space 60D, high stress is generated due to the deformation caused by the bulging phenomenon.

Therefore, in the present aspect, at least one partition rib 71 among the plurality of partition ribs 71 disposed in the trailing end space 60D extends to the interior of the adjacent space 60C, and the rigidity in the vicinity of the boundary between the adjacent space 60C and the trailing end space 60D is increased. As a result, in the present aspect, the occurrence of the bulging phenomenon is suppressed, and the deformation in the vicinity of the boundary between the adjacent space 60C and the trailing end space 60D is suppressed.

Therefore, in the present aspect, the bulging strength of the stator blades 50, 50a, and 50b can be improved, and a decrease in aerodynamic performance and durability of the stator blades 50, 50a, and 50b due to the occurrence of a bulging phenomenon can be suppressed.

(2) In the stator blade according to a second aspect, in the stator blade 50 according to the first aspect, the extending partition rib 71a is disposed at a position of 30% to 70% of a dimension of the trailing end space 60D in the blade height direction Dh from an end on one side of the trailing end space 60D in the blade height direction Dh.

Around the adjacent space 60C in the blade body 51, the amount of deformation caused by the bulging phenomenon increases in the vicinity of the central portion of the blade body 51 in the blade height direction Dh. Therefore, in the present aspect, among the plurality of the partition ribs 71, the partition rib 71 disposed at a position of 30% to 70% of a dimension of the trailing end space 60D in the blade height direction Dh from an end on one side of the trailing end space 60D in the blade height direction Dh, in other words, the partition rib 71 disposed at the central portion in the blade height direction Dh in the blade body 51, is referred to as the extending partition rib 71a. As a result, in the present aspect, the deformation in the vicinity of the boundary between the adjacent space 60C and the trailing end space 60D and in the central portion of the blade body 51 in the blade height direction Dh can be suppressed.

(3) In the stator blade according to a third aspect, in the stator blade 50a according to the first aspect or the second aspect, all of the plurality of partition ribs 71 are the extending partition ribs 71a and 71b.

In the present aspect, the overall rigidity can be increased in the vicinity of the boundary between the adjacent space 60C and the trailing end space 60D and in the blade height direction Dh of the blade body 51.

(4) In the stator blade according to a fourth aspect, in the stator blades 50, 50a, and 50b according to any one of the first to third aspects, the extension dimension L by which the extending partition ribs 71a and 71b extend to the interior of the adjacent space 60C from an edge on the side of the leading edge 52 of the trailing end space 60D is smaller than twice the boundary width W that is an interval between the positive pressure-side inner wall surface 63Dp and the negative pressure-side inner wall surface 63Dn in the edge on the side of the leading edge 52 of the trailing end space 60D.

The extension dimension L of the extending partition ribs 71a and 71b may be larger than twice the boundary width W. In this case, although the bulging strength of the blade body 51 increases as compared with a case where the extension dimension L of the extending partition ribs 71a and 71b is set to be twice the boundary width W, the amount of increase in the bulging strength is smaller than the amount of increase in the extension dimension L. In addition, since the stator blades 50, 50a, and 50b are formed by casting, in a case where the extension dimension L of the extending partition ribs 71a and 71b is increased, the difficulty of the casting increases accordingly. Therefore, in the present aspect, the increase in the bulging strength and the difficulty in casting are compared and considered, and the extension dimension L of the extending partition ribs 71a and 71b is set to be smaller than twice the boundary width W.

(5) In the stator blade according to a fifth aspect, in the stator blade 50b according to any one of the first to fourth aspects, the extending partition rib 71b is joined to the negative pressure-side inner wall surface 63Dn of the adjacent space 60C, and is not joined to the positive pressure-side inner wall surface 63Dp of the adjacent space 60C.

From the inside of the adjacent space 60C, the static pressure received by the positive pressure-side inner wall surface 63Cp defining the adjacent space 60C and the static pressure received by the negative pressure-side inner wall surface 63Cn defining the adjacent space 60C are the same value. On the other hand, since the flow speed of the combustion gas G flowing along the negative pressure surface 54 outside the blade body 51 is higher than the flow speed of the combustion gas G flowing along the positive pressure surface 55 outside the blade body 51, the static pressure received by the negative pressure surface 54 from the outside of the blade body 51 is lower than the static pressure received by the positive pressure surface 55 from the outside of the blade body 51. Therefore, the pressure difference between the pressure in the adjacent space 60C and the pressure in the region along the negative pressure surface 54 outside the blade body 51 increases as compared with the pressure difference between the pressure in the adjacent space 60C and the pressure in the region along the positive pressure surface 55 outside the blade body 51. For this reason, even in a case where a bulging phenomenon occurs around the adjacent space 60C, the amount of deformation caused by the bulging phenomenon is larger on the side of the negative pressure surface 54 than on the side of the positive pressure surface 55.

Therefore, in the present aspect, a portion of the extending partition rib 71b, which is present in the adjacent space 60C, is joined only to the negative pressure-side inner wall surface 63Cn of the inner wall surface 62C defining the adjacent space 60C, and the rigidity is increased only in the vicinity of the boundary between the adjacent space 60C and the trailing end space 60D and on the side of the negative pressure surface 54.

(6) In the stator blade according to a sixth aspect, the stator blades 50, 50a, and 50b according to any one of the first to fifth aspects further include the insert 68C of a tubular shape disposed in the adjacent space 60C.

The insert 68C is formed with the plurality of impingement holes 69 penetrating from an inner peripheral side to an outer peripheral side.

In the present aspect, the cooling air Ac that has flowed into the insert 68C is ejected from the impingement hole 69, collides with the inner wall surface 62C defining the adjacent space 60C, and performs impingement cooling on the inner wall surface 62C.

For this reason, in the present aspect, the blade surface along the inner wall surface 62C defining the adjacent space 60C can be efficiently cooled.

For example, the gas turbine in the above-described embodiment is understood as follows.

(7) A gas turbine according to a seventh aspect includes the stator blades 50, 50a, and 50b according to any one of the first to sixth aspects, the rotor 41 that rotates about the axis Ar, and the casing 45 that covers an outer peripheral side of the rotor 41.

The stator blades 50, 50a, and 50b are fixed to an inner peripheral surface of the casing 45.

### INDUSTRIAL APPLICABILITY

According to one aspect of the present disclosure, the bulging strength of a stator blade can be improved, and a decrease in aerodynamic performance and durability of the stator blade can be suppressed.

### REFERENCE SIGNS LIST

10: Gas turbine
11: Gas turbine rotor
15: Gas turbine casing
16: Intermediate casing
20: Compressor
21: Compressor rotor
22: Rotor shaft
23: Rotor blade row
25: Compressor casing
26: Stator blade row
30: Combustor
40: Turbine
41: Turbine rotor
42: Rotor shaft
43: Rotor blade row
45: Turbine casing
46: Stator blade row
49: Combustion gas passage
50, 50a, 50b: Stator blade
51: Blade body
52: Leading edge
53: Trailing edge
54: Negative pressure surface
55: Positive pressure surface
57: First partition wall
58: Second partition wall
60: Cooling air space
60A: First space
62A: Inner wall surface
67A: First blade surface cooling passage
68A: First insert
69: Impingement hole
60B: Second space
62B: Inner wall surface
67B: Second blade surface cooling passage
68B: Second insert
60C: Third space (adjacent space)
61C: Opening
62C: Inner wall surface
63Cp: Positive pressure-side inner wall surface
63Dn: Negative pressure-side inner wall surface
65C: Blade height second-side inner wall surface
66C: Second partition wall surface
67C: Third blade surface cooling passage
68C: Third insert
60D: Fourth space (trailing end space)
61D: Opening
62D: Inner wall surface
63Dp: Positive pressure-side inner wall surface
63Dn: Negative pressure-side inner wall surface
64D: Blade height first-side inner wall surface
65D: Blade height second-side inner wall surface
67D: Trailing end cooling passage
71: Partition rib
71a, 71b: Extending partition rib
72: Pin
80i: Inner shroud
80o: Outer shroud
81i, 81o: Shroud body
82i, 82o: Gas path surface
83i, 83o: Counter gas path surface
84i, 84o: Peripheral wall
85i, 85o: Cavity
86i: Retainer
88i: Inner impingement plate
88o: Outer impingement plate
89: Impingement hole
A: Air
Ac: Cooling air
F: Fuel
G: Combustion gas
Ar: Axis
CL: Camber line
Da: Axial direction
Dau: Axial upstream side
Dad: Axial downstream side
Dc: Circumferential direction
Dr: Radial direction
Dri: Radial inner side
Dro: Radial outer side
Dh: Blade height direction
Dh1: Blade height first side
Dh2: Blade height second side
L: Extension dimension
W: Boundary width

1. A stator blade included in a gas turbine, the stator blade comprising:
a blade body of which a shape forms a blade shape in a cross section and that extends in a blade height direction having a direction component perpendicular to the cross section, wherein
the blade body includes a leading edge and a trailing edge that extend in the blade height direction, a positive pressure surface and a negative pressure surface that extend in the blade height direction and that connect the leading edge and the trailing edge, a trailing end space and an adjacent space that are positioned between the leading edge and the trailing edge and between the positive pressure surface and the negative pressure surface, and a plurality of trailing end cooling passages that penetrate from the trailing end space to the trailing edge,
the adjacent space is positioned further on a side of the leading edge than the trailing end space,
an edge of the trailing end space on the side of the leading edge is open and communicates with the trailing end space,
both the adjacent space and the trailing end space are each defined by an inner wall surface,
both the inner wall surface of the adjacent space and the inner wall surface of the trailing end space each include a positive pressure-side inner wall surface that extends along the positive pressure surface, and a negative pressure-side inner wall surface that extends along the negative pressure surface and that is separated from the positive pressure-side inner wall surface toward a side of the negative pressure surface,
the positive pressure-side inner wall surface of the adjacent space and the positive pressure-side inner wall surface of the trailing end space are connected to each other,
the negative pressure-side inner wall surface of the adjacent space and the negative pressure-side inner wall surface of the trailing end space are connected to each other,
a plurality of partition ribs, which are aligned in the blade height direction and partition the trailing end space in the blade height direction, and a plurality of pins are disposed in the trailing end space,
all of the plurality of pins are joined to the positive pressure-side inner wall surface of the trailing end space and to the negative pressure-side inner wall surface of the trailing end space, and
at least one partition rib among the plurality of partition ribs forms an extending partition rib that extends to an interior of the adjacent space and is joined to the inner wall surface which defines the adjacent space.

2. The stator blade according to claim 1, wherein the extending partition rib is disposed at a position of 30% to 70% of a dimension of the trailing end space in the blade height direction from an end on one side of the trailing end space in the blade height direction.

3. The stator blade according to claim 1, wherein all of the plurality of partition ribs are the extending partition rib.

4. The stator blade according to claim 1, wherein an extension dimension by which the extending partition rib extends to the interior of the adjacent space from an edge on the side of the leading edge of the trailing end space is smaller than twice a boundary width that is an interval between the positive pressure-side inner wall surface and the negative pressure-side inner wall surface in the edge on the side of the leading edge of the trailing end space.

5. The stator blade according to claim 1, wherein the extending partition rib is joined to the negative pressure-side inner wall surface of the adjacent space and is not joined to the positive pressure-side inner wall surface of the adjacent space.

6. The stator blade according to claim 1, further comprising:
an insert of a tubular shape disposed in the adjacent space, wherein
the insert is provided with a plurality of impingement holes penetrating from an inner peripheral side to an outer peripheral side.

7. A gas turbine comprising:
the stator blade according to claim 1;
a rotor that rotates about an axis; and
a casing that covers an outer peripheral side of the rotor, wherein
the stator blade is fixed to an inner peripheral surface of the casing.
